(19) United States
(12) Patent Application Publication
(10) Pub. No.: US 2015/0006798 A1
(43) Pub. Date: Jan. 1, 2015

(54) AUTOMATICALLY UPDATING ADVERTISING CONTENT VIA A USB FLASH DRIVE

(71) Applicant: IMAGINE MEDIA PARTNERS, LLC, Seattle, WA (US)

(72) Inventors: Tolga Ural, Seattle, WA (US); Jonathan Norris, Seattle, WA (US)

(73) Assignee: IMAGINE MEDIA PARTNERS, LLC, Seattle, WA (US)

(21) Appl. No.: 14/487,789

(22) Filed: Sep. 16, 2014

Related U.S. Application Data
(63) Continuation of application No. 12/371,495, filed on Feb. 13, 2009.

(51) Int. Cl. G06F 12/02

(52) U.S. Cl. CPC G06F 12/0246; G06Q 30/0241
USPC 711/103

(57) ABSTRACT

Systems and methods are provided herein that provide for the automatic updating of advertising content via USB flash drives.

### CROSS-REFERENCE TO RELATED APPLICATIONS

This application is a continuation of U.S. Non-Provisional application Ser. No. 12/371,495 filed Feb. 13, 2009, entitled “DIGITAL MEDIA ADVERTISEMENT SYSTEM AND METHOD.” which claims priority to U.S. Provisional Application 61/028,455 filed Feb. 13, 2008 entitled “DIGITAL MEDIA ADVERTISEMENT SYSTEM AND METHOD.” The foregoing applications are hereby incorporated by reference in their entirety as if fully set forth herein.

### FIELD

This invention relates generally to advertisement and promotion of goods and services, and more specifically, to systems and methods for updating advertising content via a USB flash drive.

### BACKGROUND

Examples of early advertising may be found in artifacts from ancient Arabia, Egypt and Rome; however, advertising began to grow in quantity and popularity with the emergence of printing in the 15th and 16th century. Today, advertising comes in a multitude of forms including print, radio, television, and on the Internet.

One form of advertisement is the distribution of media devices such as CDs or other memory devices that store and present advertising content. However, such memory devices are conventionally only operable to present advertising content that is stored on the memory device and therefore once the advertising content stored on the memory device is stale, there is no way to update the stale content with fresh and updated content. Additionally, conventional media devices trigger various dialog boxes or warnings that impede the user experience and cause undesirable barriers to viewing and interacting with advertising content.

### BRIEF DESCRIPTION OF THE DRAWINGS

The present disclosure will be presented by way of exemplary embodiments but not limitations, illustrated in the accompanying drawings in which like references denote similar elements, and in which:

FIG. 1 is a pictorial diagram of a system of interconnected devices, in accordance with various embodiments.

FIG. 2 is a block diagram of a memory device in accordance with various embodiments.

FIG. 3 is a diagram illustrating the actions taken by a user device, a content server, and an advertiser server in relation to a media drive, in accordance with various embodiments.

FIG. 4 is a flow diagram illustrating an advertising media updating routine in accordance with various embodiments.

FIG. 5 is a flow diagram illustrating an auto-run routine in accordance with various embodiments.

FIG. 6 is an illustration of an exemplary graphic user interface, in accordance with various embodiments.

FIG. 7 is an illustration of an exemplary graphic user interface, in accordance with various embodiments.

FIG. 8 is an illustration of an exemplary graphic user interface, in accordance with various embodiments.

FIG. 9 is an illustration of an exemplary graphic user interface, in accordance with various embodiments.

FIG. 10 is an illustration of an exemplary graphic user interface, in accordance with various embodiments.

### DETAILED DESCRIPTION OF THE PREFERRED EMBODIMENTS

Illustrative embodiments presented herein include, but are not limited to, systems and methods for advertisement and promotion via digital media.

Various aspects of the illustrative embodiments will be described using terms commonly employed by those skilled in the art to convey the substance of their work to others skilled in the art. However, it will be apparent to those skilled in the art that the embodiments described herein may be practiced with only some of the described aspects. For purposes of explanation, specific numbers, materials and configurations are set forth in order to provide a thorough understanding of the illustrative embodiments. However, it will be apparent to one skilled in the art that the embodiments described herein may be practiced without the specific details. In other instances, well-known features are omitted or simplified in order not to obscure the illustrative embodiments.

Further, various operations and/or communications will be described as multiple discrete operations and/or communications, in turn, in a manner that is most helpful in understanding the embodiments described herein; however, the order of description should not be construed as to imply that these operations and/or communications are necessarily order dependent. In particular, these operations and/or communications need not be performed in the order of presentation.

The phrase “in one embodiment” is used repeatedly. The phrase generally does not refer to the same embodiment; however, it may. The terms “comprising,” “having” and “including” are synonymous, unless the context dictates otherwise.

The following Figures depict systems and methods for advertisement and promotion via digital media. In various exemplary embodiments, a media drive can automatically launch a media browser when the media drive is read by a user device and present promotional media content stored on the media drive. Where the user device has internet connectivity, various aspects or elements of the promotional media content can be obtained from remote servers.

For example, in one embodiment, the media drive can present a digital auction that facilitates a plurality of users placing bids on auction items and receiving an updated status of the auction and the auction's items. In other embodiments promotional content such as logos and text can be updated and/or appended via remote servers when there is internet connectivity, or default promotional content can be obtained from the media drive where internet connectivity is unavailable.

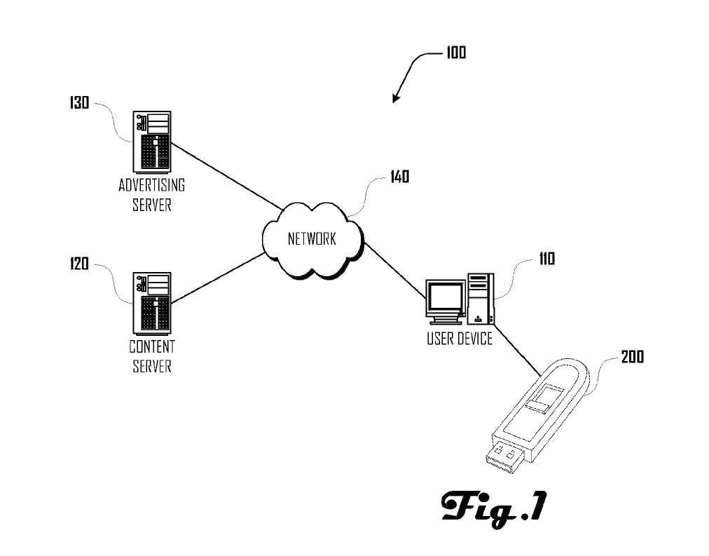

FIG. 1 is a pictorial diagram of a system of interconnected devices 100, in accordance with an example embodiment, which comprises a user device 110, a content server 120, and an advertiser server 130, which are operationally connected via a network 140. Additionally, a media drive 200, is operationally connected or in communication with the user device 110.

In the example embodiment of FIG. 1, the content server 120 may be associated with a company that produces a media drive 200, that comprises advertisements for a plurality of advertisers, and one or more advertiser may be associated with an advertiser server 130. Additionally, the media drive 200 may be configured such that when the media drive 200 is read by a user device 110, the user device 110 requests additional media from one or more of the advertiser server 130 and the content server 120. In one embodiment, there may be a plurality of the user device 110, media drive 200, content server 120, advertiser server 130 or the network 140.

For example, when the user device 110 reads the media drive 200, the user device 110 may be instructed to request content from the content server 120 and the advertiser server 130. In one embodiment, the advertiser server 130 may be associated with a single advertiser associated with the media drive 200, and the advertiser may update and/or append content on the advertiser server 130 such that the media drive 200 causes the updated and/or appended content to be obtained by the user device 110. In one example, updated or appended content may be coupons, specials, sales, menus, and the like. Similarly, when the user device 110 reads the media drive 200, the user device 110 may be instructed to request content from the content server 120, which may be associated with a company or other entity that produced the media drive 200, and the company may update and/or append content on the content server 120 such that updated and/or appended content obtained by the user device 110. In one example, updated and/or appended content may include images, text, page data, hyperlink data, and the like.

For purposes of illustration only, embodiments comprising a USB flash memory media drive 200 are described herein; however, it should be clear that various memory devices may be used, which will be within the scope and spirit of various embodiments. For example, in one embodiment, the media drive 200 as described herein may be a semiconductor memory device, Compact Disc (CD), flash memory device, magnetic memory device, optical memory device, phase change memory device, holographic memory device, molecular memory device, and the like.

In another embodiment, the media drive 200 may be various types of optical media including Compact Disc, MiniDisc, Digital Versatile Disc (“DVD”), High-Definition DVD (“HD-DVD”), Blu-ray Disc, Ultra Density Optical (“UDO”), Universal Media Disc (“UDO”), and the like. In one embodiment, a media drive 200 may serve a plurality of functions. For example, a media drive 200 may function as an audio CD when read by a CD player and may serve as a multi-media CD when read by a CD-ROM device.

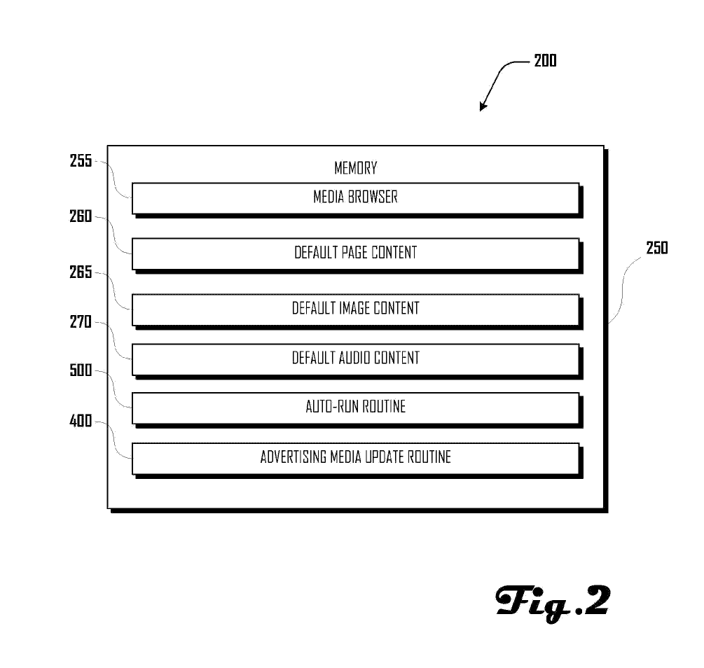

FIG. 2 illustrates several components stored on an exemplary media drive 200 for an embodiment. In various embodiments, the media drive 200 may comprise many more components than those shown in FIG. 2. However, it is not necessary that all of these generally conventional components be shown in order to disclose an enabling embodiment for practicing the embodiments described herein.

As shown in FIG. 2, the media drive 200 may include a memory 250 that stores the program code necessary for a media browser 255, page content 260, image content 265, audio content 270, an advertising media update routine 400 and an auto-run routine 500. In some embodiments, the media drive 200 may comprise a general media update routine, a news media update routine, an auction media update routine, and the like. It will be appreciated that the software components may be loaded or written onto a media drive 200 through various methods.

In one embodiment, the media browser 255 may be various types of web or media browsers, which may include Internet Explorer, Firefox, Safari, Opera, Netscape, and the like. Additionally, the media browser 255 may be a custom-designed media browser 255.

In one embodiment, the page content 260 may be viewed via a media browser 255 and page content 260 may be one of various types of graphic user interfaces. An example of a graphical user interface is an interactive media page, e.g., in HTML (HyperText Markup Language), Flash, JavaScript, VBScript, JScript, ASP.NET, PHP (HTML Preprocessor) or XHTML (eXtensible HyperText Markup Language) form, or the like. Resultantly, since users are generally familiar with the user interfaces of media pages, including sophisticated web pages such as Flash-enabled web pages from Macromedia, incorporated of San Francisco, Calif., consumption of services using a media page based graphical user interface (e.g., displayed on a user device 110) may be made familiar and user friendly.

For example, page content 260 may incorporate text content, image content 265, audio content 270, and other forms of multi-media content. For example, image content 265 may include digital images of various file formats, including Joint Photographic Experts Group (“JPEG”), Graphics Interchange Format (“GIF”), Tagged Image File Format (“TIFF”), and the like. Audio content 270 may include various types of digital audio media in various formats including WAVE, WAV, MPEG-1 Audio Layer 3 (“MP3”), Windows Audio Media (“WMA”), Real Audio (“RA”), and the like. In various embodiments, media content may comprise news content, auction content, advertising content, and the like.

Although an exemplary media drive 200 has been described that generally conforms to a conventional general-purpose memory device, various embodiments envision that a media drive 200 may be any of a great number of devices capable of functioning as a memory device or media drive 200 that is within the spirit or scope of the embodiments described herein or may perform at least one function of the embodiments described herein.

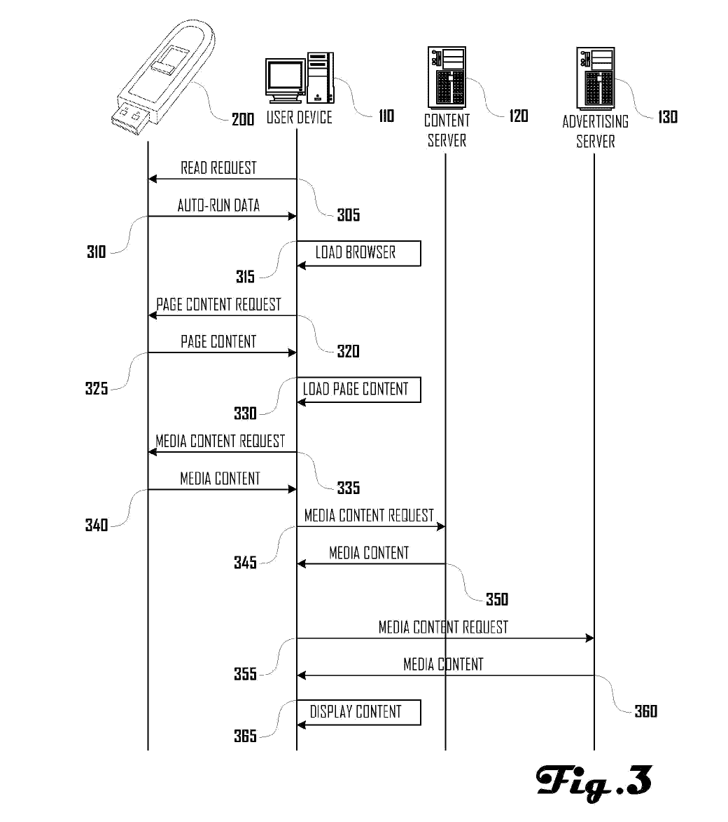

The following FIG. 3 depicts exemplary actions taken by various devices according to various embodiments. In one example, a user may insert a media drive 200 into the user device 110 and upon reading the media drive 200, the user device 110 may execute an auto-run routine 500. The auto-run routine 500 may load a media browser 255 from the media drive 200, may load page content 260 from the media drive 200 and display page content 260 in the media browser 255. The user device 110 may then request the most current media content from the media drive 200, and other remote devices to obtain the most current available media. Such most current available media may be displayed in the media browser 255.

FIG. 3 is a diagram illustrating the actions taken by a user device 110, a content server 120 and an advertiser server 130 in relation to a media drive 200, in accordance with various embodiments. The actions begin where the user device 110 sends 305 a read request to the media drive 200 and auto-run data 500 is obtained 310 by the user device 110. For example, in one embodiment, the media drive 200 may be a USB flash drive, which may be read by the user device 110 after insertion into a USB port present on the user device 110-, which is a process that is well known in the art. Upon obtaining 310 auto-run data 500 and running the auto-run routine 500, the user device 110 loads 315 a media browser 255, the code for which is stored on the media drive 200. For example, in one embodiment, the user device 110 may temporarily load or temporarily install the media browser 255.

The user device 110, then requests 320 page content 260 from the media drive 200 and page content 260 is obtained 325 by the user device 110, which loads 330 the page content 260. The user device 110 may then request 335 media content from the media drive 200 that is to be displayed with the page content 260. In one embodiment, media content may include image content 265, audio content 270, and other forms of digital media. The user device 110 may also request 345 media content from the content server 120 and may request 355 media content from the advertiser server 130. Additionally, the user device 110 may obtain 350 media content from the content server 120 and may obtain 360 media content from the advertiser server 130.

The user device 110 may then display 365 obtained content. For example, the user device 110 may request updated and/or appended media content associated with loaded 330 page content 260, and where updated and/or appended media content is available the user device 110 may obtain 350, 360 such content, otherwise, the user device 110 may obtain media content from the media drive 200. In some embodiments, media content obtained from a given server can be the same or different from the media content obtained from another server.

In various embodiments, a portion of data stored on a media drive 200 may be stored on a user device 110 that reads the media drive 200. For example, media browser data 255, default page content 260, default image content 265, default audio content 270, auto-run routine data 500 advertising media update routine data 400, default advertising data, and the like, may be stored in a hard drive, cache, RAM memory, and the like.

Additionally, in further embodiments, data, content or media obtained from a content server 120 or an advertising server 130 may be stored on a user device 110. In such embodiments, an advertising media update routine 400 may determine if updated media content, further updated media content, or default media content is stored locally, and display such content selectively. For example, if a user device is unable to connect to a remote server such as a content server 120 or advertising server 130, the advertising media update routine may display updated or further updated advertising media content stored locally on the user device 110. In various embodiments, news data, auction data, and the like may also be stored and retrieved from the user device 110.

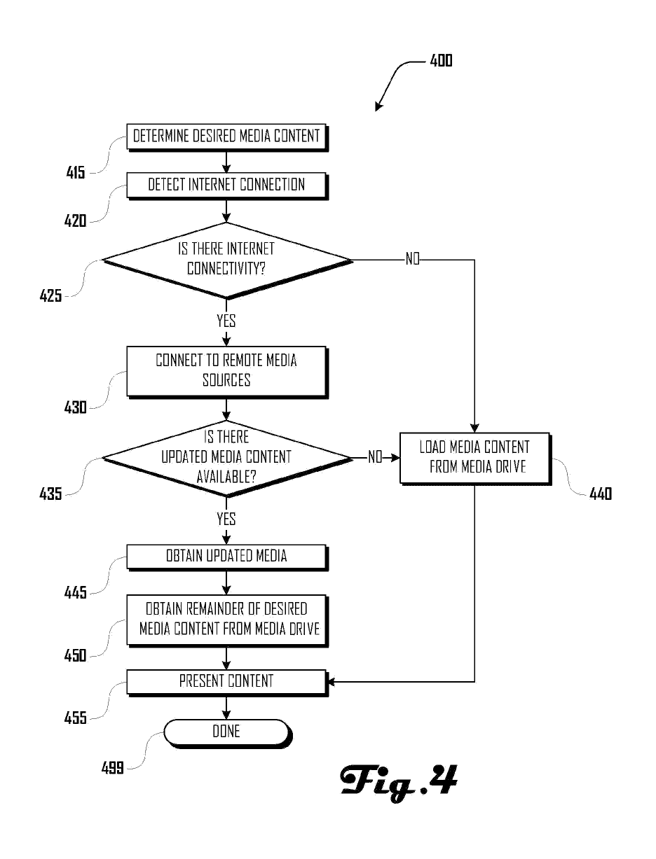

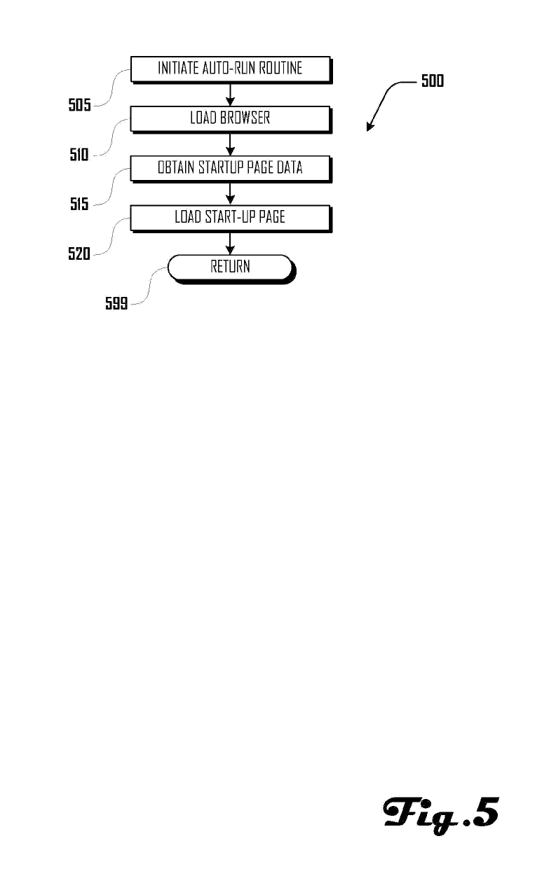

The following FIGS. 4-5 depict routines according to various embodiments. For example, one routine allows updated and/or appended media content to be obtained, which is associated with a given media drive 200. In one routine, a startup page may be loaded.

FIG. 4 is a flow diagram illustrating an advertising media update routine 400 in accordance with various embodiments. In block 415 desired media content is determined. For example in one embodiment, desired media content may be page content 260, image content 265, audio content 270 or other digital media stored on the media drive 200, a remote server, the user device 110, or the like. Desired media content may be media content that is associated with a graphic user interface, which may comprise page content 260 stored on the media drive 200 or elsewhere. For example, the graphic user interface may include various fields of text or images that may be stored on the media drive 200 and updates to and/or appended media relating to the same text or images may be stored on a remote server.

In block 420 internet connectivity is detected and in decision block 425, a determination is made whether internet connectivity is present. If internet connectivity is not present, desired media content is loaded from the media drive 200 in block 440 and content is presented in block 455; however, if internet connectivity is present, an operational connection is made with remote media sources in block 430. In decision block 435, a determination is made whether there is updated and/or appended media content available. If there is not updated and/or appended media content available, desired media content is loaded from the media drive 200 in block 440 and content is presented in block 455; however, if there is updated and/or appended media content available, updated and/or appended media content is obtained in block 445. In block 450, the remainder of desired media content is obtained from the media drive 200 and content is presented in block 455. The content presentation routine 400 is then done 499.

In one embodiment, obtaining media from a remote media source may be a default action which may be performed if internet connectivity is present; however, if internet connectivity is not present, then media content may be obtained from the media drive 200. In another embodiment, different media content may be presented depending on whether it is possible to obtain media from a remote source. For example, internet connectivity may be detected and if internet connectivity is not present, then default media content may be presented that is obtained from the media drive 200. However, if internet connectivity is present, a different set of content may be presented, which may be obtained from remote sources or the media drive 200. In a still further embodiment, media content may be obtained from the user device 110 reading the media drive 200.

FIG. 5 is a flow diagram illustrating an auto-run routine 500 in accordance with various embodiments. The auto-run routine 500 begins where the auto-run routine is initiated in block 505 and then a browser is loaded in block 510. In one embodiment, a media browser 255 may be obtained from a media drive 200, a remote content source, or a user device 110 reading a media drive 200. The auto-run routine 500 continues in block 515, where startup-page data is obtained and then loaded in block 520. The subroutine then returns 599. In various embodiments, execution of the auto-run routine 500 may be desirable because it allows content to be presented without triggering one or more dialog box or warning that may impede the user experience.

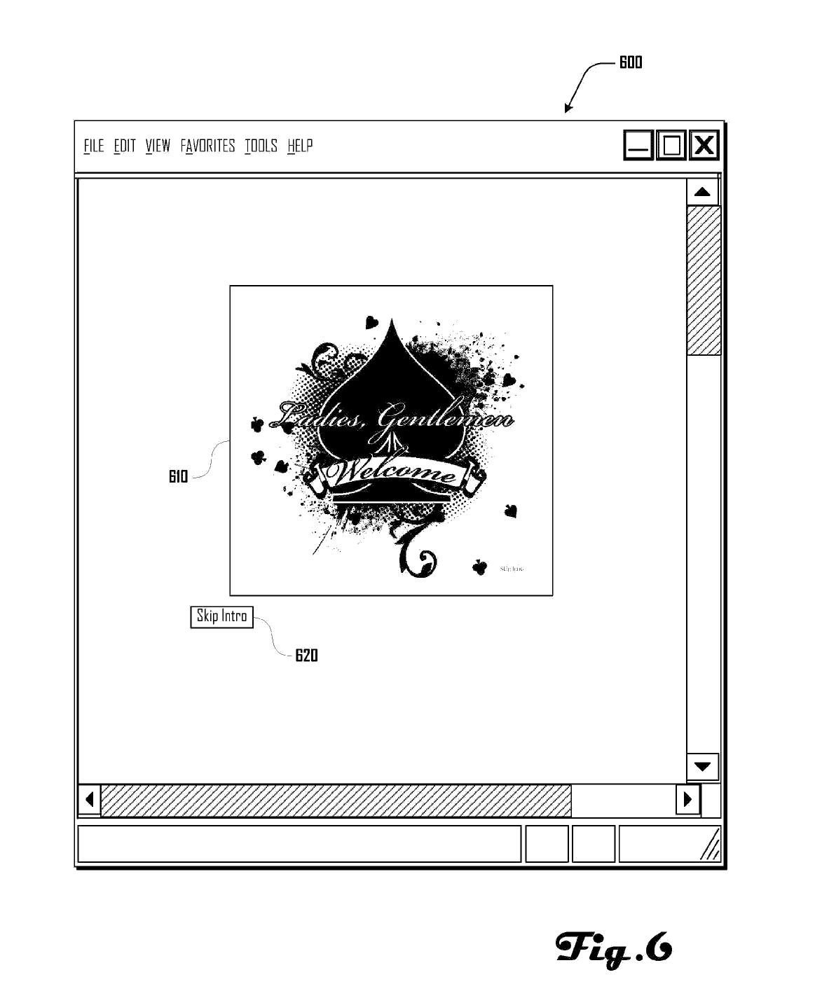

The following FIGS. 6-10 depict exemplary graphic user interfaces in accordance with various embodiments. These exemplary graphic user interfaces are only some of the multitude of possible user interfaces and that the examples herein should not in any way be construed to limit the scope of other possible embodiments. The graphic user interfaces depicted herein may be linked together via hyperlinks, be stand-alone graphic user interfaces, or be linked to other graphic user interfaces, internet web pages, or the like.

FIG. 6 is an illustration of an exemplary graphic user interface 600, in accordance with various embodiments, which comprises a flash media graphic 610 and a skip intro hyperlink 620. The flash media graphic 610 may be an interactive media presentation that welcomes a user to the graphic user interface 600 and introduces the user to the content of other pages of the graphic user interface 600. The skip intro hyperlink may allow a user to advance to another page of the graphic user interface 600 without viewing the full media presentation of the flash media graphic 610. In one embodiment, the flash media graphic 600 may include audio media, audio media may be played in association with the displayed page, or an audio media player may be imbedded in the graphic user interface 600, or the like.

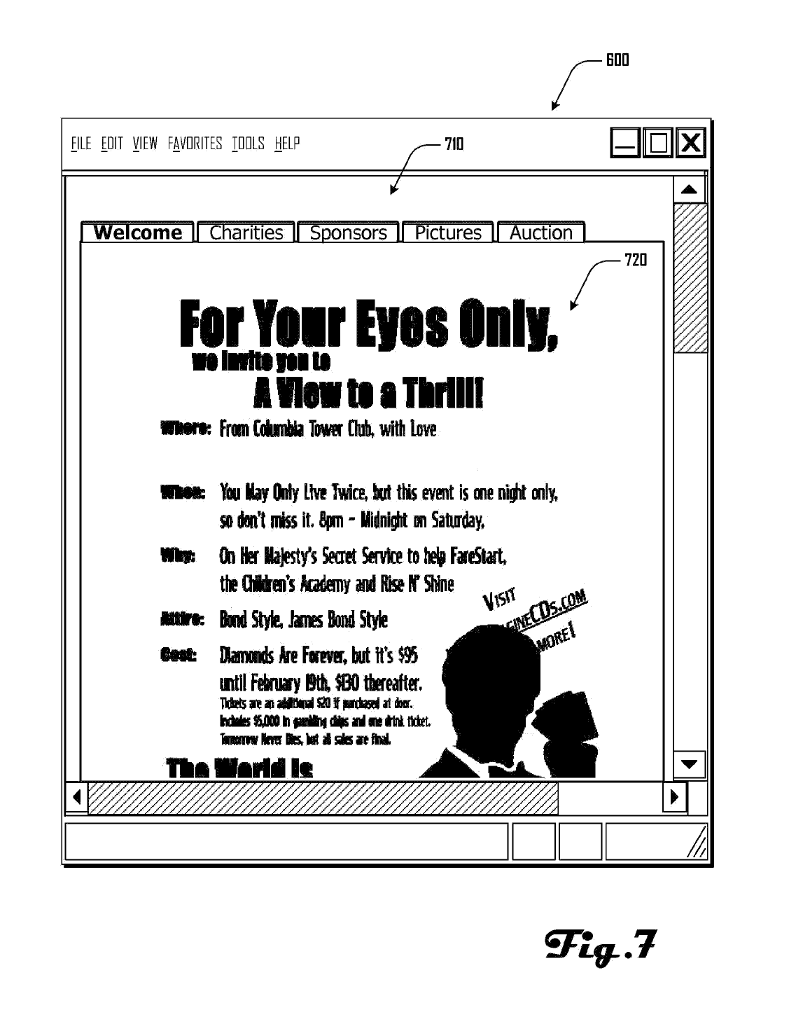

FIG. 7 is an illustration of an exemplary graphic user interface 600, in accordance with various embodiments, which comprises a menu bar 710 and event content 720. The menu bar 710 as depicted here, comprises a tab for Welcome’, ‘Charities’, ‘Sponsors’, ‘Pictures,’ and Auction.’ Each menu bar tab may be a hyperlink that allows a user to view content associated with the given tab. Here, the ‘Welcome’ tab is highlighted, which indicated that content associated with the ‘Welcome’ tab is being displayed, which here is the event content 720. Event content 720 may include any type of media, including text, images, audio media, a combination thereof, or the like.

In one embodiment, some event content 720 may be obtained from a media drive 200 and displayed, some event content 720 may be obtained from a remote media server, or the like. For example, the graphic user interface 600 may obtain an image from the media drive 200, but seek updated and/or appended text content. This may be desirable in some embodiments because the date of an event may change, the cost may change, details about the event may be changed, or details about the event may be added. In one example relating to the event content 720 depicted here, the cost of the event is $95 until February 19th, and then the cost of the event is $130. Accordingly, after February 19th the event content 720 may be changed to only display the current price of the event (i.e. $130) instead of the previous price (i.e. $95). Additionally, when the event is over, the event content 720 may be changed to reflect that the event date has passed, information about the event's occurrence, or information about another event that is yet to occur (e.g. next year's event). On the other hand if updated and/or appended event content 720 is unavailable due to lack of connectivity to a remote content server 120, default event content may be obtained from the media drive 200.

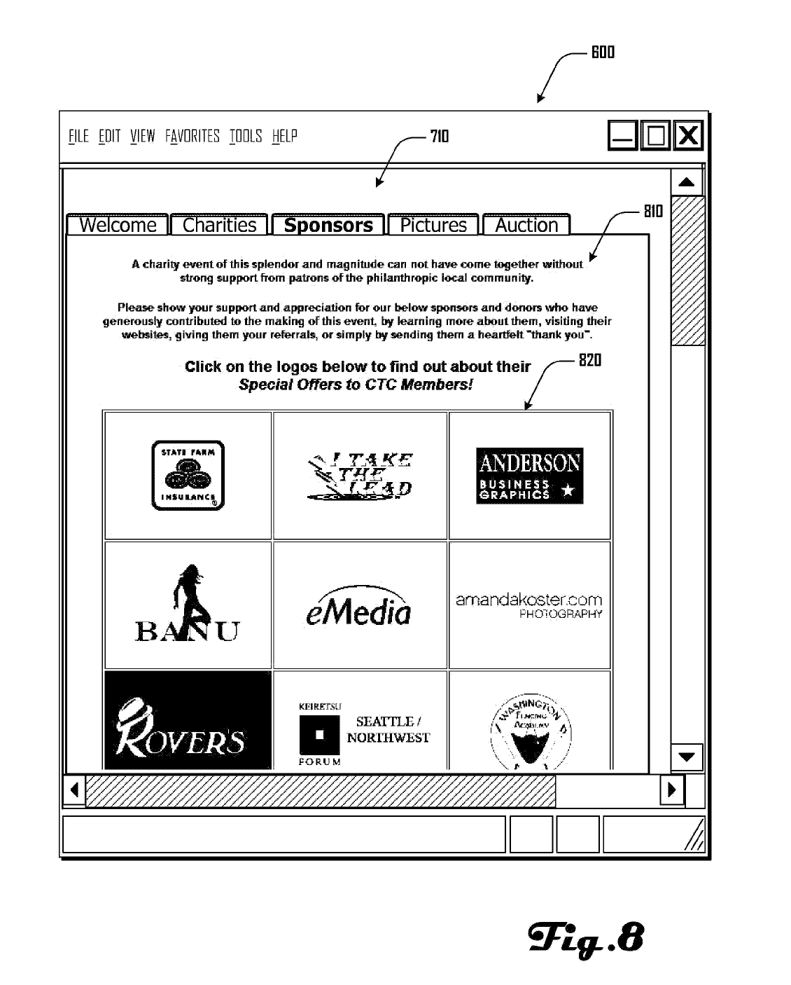

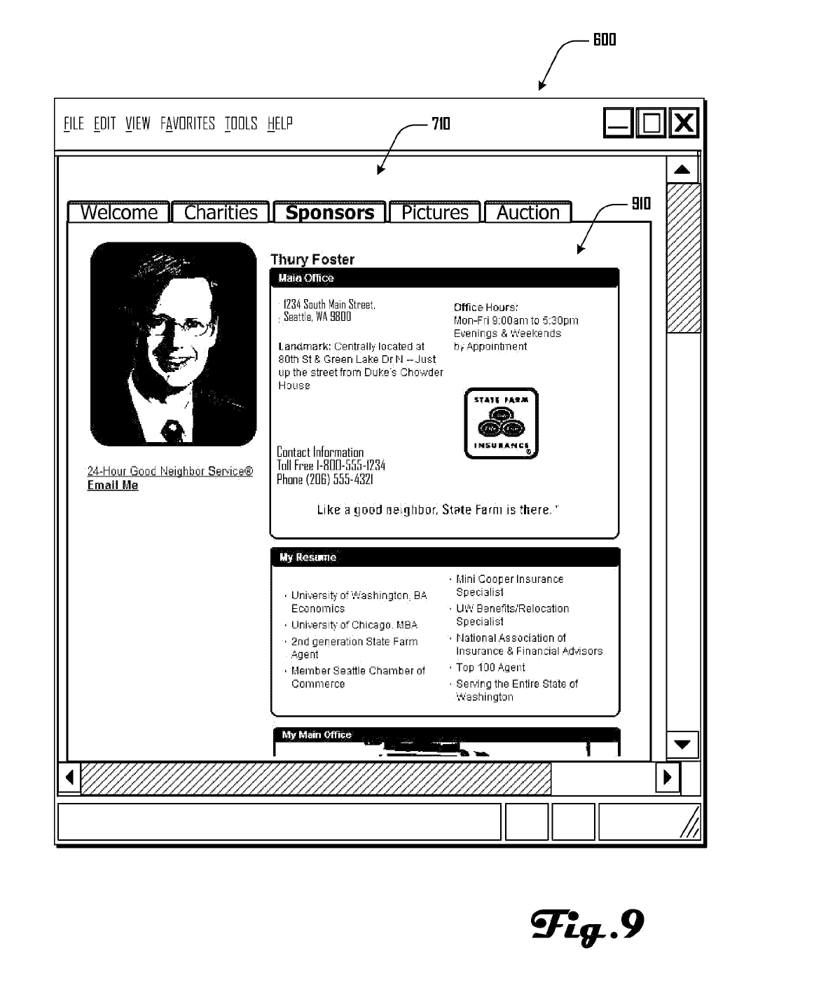

FIG. 8 is an illustration of an exemplary graphic user interface 600, in accordance with various embodiments, which comprises a menu bar 710 sponsor text content 810 and sponsor image content 820. As depicted in FIG. 8, the ‘Sponsor’ tab of the menu bar 710 is highlighted, which indicates that content associated with the ‘Sponsor’ tab is being displayed. Here, sponsor text content 810 comprises information about the sponsors of the event and the sponsor image content 820 is a matrix of logos associated with various event sponsors. In one embodiment, a user may click a sponsor logo and open a page about the sponsor, a coupon from the sponsor, the sponsor's webpage or the like (see, e.g. FIG. 9).

In another embodiment, images associated with each sponsor may be stored on the media drive 200, may also be stored on a content server 120, or may be stored on an advertiser server 130 that is associated with a specific sponsor. Where there is lack of connectivity to a remote server that stores a sponsor image, an image may be obtained from the media drive 200. However, where there is connectivity to a remote server that stores a sponsor image, the image may be obtained from such a remote server. For example, a sponsor may store it's logo on an advertiser server 130 associated with the sponsor, and may change or update this logo as desired. Similarly, logos from sponsors may be stored on a content server 120, and a content server administrator may change, update or append these logos as desired. This may be desirable in some embodiments because a sponsor may change its logo and the sponsor may update an image stored on its advertiser server 130 or a content server administrator may update an image stored on the content server 120, which may allow the updated logo to be viewed by users of the media drive 200.

In another embodiment, sponsors can be removed or appended. For example, it may be desirable to add more event sponsors and where there is internet connectivity, page content and/or media content can be changed, updated or appended such that sponsors are added or removed. In some embodiments, the media drive 200 may comprise default advertising content that may or may not be associated with a first advertiser. The content server 120 may store updated advertising content that may be associated with the first advertiser, one of a plurality of advertisers, no advertiser, and the like. Additionally, the advertising server 130 may store advertising content associated with the first advertiser, or one of a plurality of advertisers.

In one example, default advertising data may comprise a placeholder, which may be replaced by updated advertising data associated with an advertiser. In another example, default advertising data may comprise advertising data associated with a first advertiser, which may be replaced by updated advertising data associated with the same first advertiser. In a further example, default advertising data may comprise advertising data associated with a first advertiser, which may be replaced by updated advertising data associated with the same first advertiser or may be replaced by further updated advertising data stored on an advertising server 130. In various embodiments, updated advertising data or further updated advertising data may be preferentially displayed in place of default advertising data.

FIG. 9 is an illustration of an exemplary graphic user interface 600, in accordance with various embodiments, which comprises a menu bar 710 and sponsor content 910. As depicted in FIG. 9, the ‘Sponsor’ tab of the menu bar 710 is highlighted, which indicates that content associated with the ‘Sponsor’ tab is being displayed. As described herein, text, images and other media comprising the sponsor content may be stored on the media drive 200, a remote server, or a combination thereof, which may be desirable in some embodiments because sponsor content 910 may be changed at the desire of sponsors, media drive producers, content server administrators, and the like. In an example relating to the sponsor content 910 depicted in FIG. 9, the sponsor may change his phone number, place of business, office hours, resume, picture, or the like, and updates to such content may be made and stored on a remote server which may be obtained by a user device 110 reading the media drive 200.

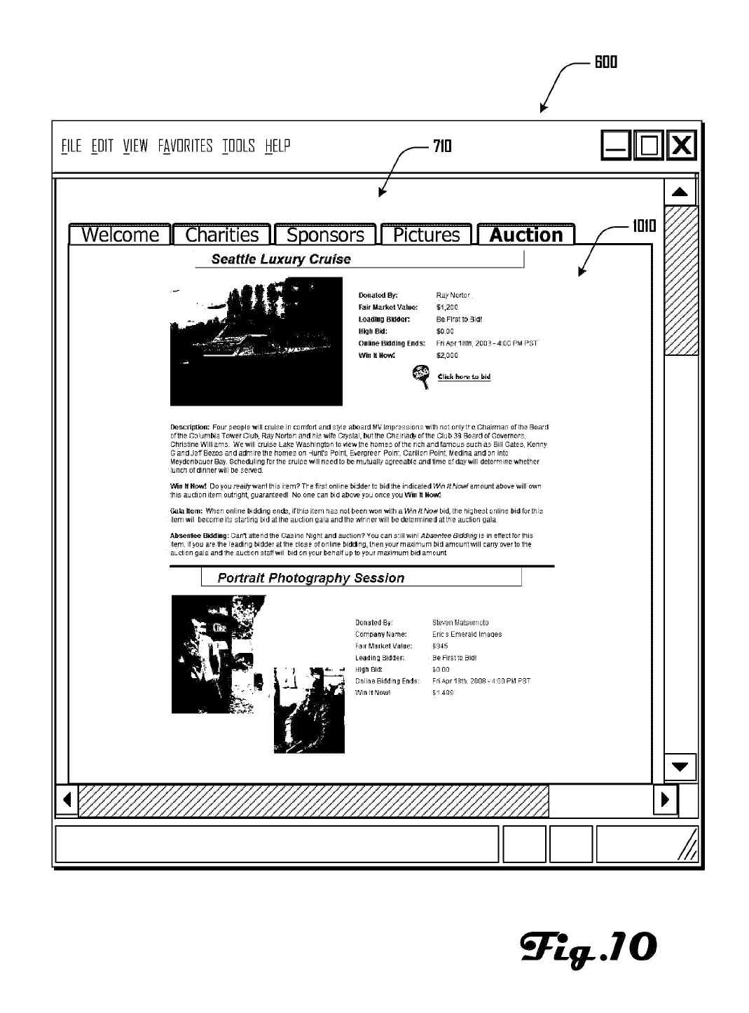

FIG. 10 is an illustration of an exemplary graphic user interface 600, in accordance with various embodiments, which comprises a menu bar 710 and auction content 1010. As depicted in FIG. 10, the ‘Auction’ tab of the menu bar 710 is highlighted, which indicates that content associated with the ‘Auction’ tab is being displayed. As described herein, content may be changed and updated on a remote server and retrieved by a user device 110 reading the media drive 200. In an example relating to the auction content 1010 depicted in FIG. 10, auction content may be updated, which may include addition of new auction items, removal of auction items, a change of auction item information, display of current bids on an auction item, availability of an auction item, and the like.

Additionally, although specific embodiments have been illustrated and described herein, it will be appreciated by those of ordinary skill in the art and others, that a wide variety of alternate and/or equivalent implementations may be substituted for the specific embodiment shown in the described without departing from the scope of the embodiments described herein. This application is intended to cover any adaptations or variations of the embodiment discussed herein. While various embodiments have been illustrated and described, as noted above, many changes may be made without departing from the spirit and scope of the embodiments described herein.

What is claimed is:

1. A computer implemented method of presenting and updating media content with a USB flash drive, the method comprising;
coupling a USB flash drive with a user device;
the user device automatically reading the USB flash drive;
the user device running an auto-run routine stored on the USB flash drive that presents a browser on the user device using browser data stored on the USB flash drive;
the auto-run routine causing the user device to obtain page content stored on the USB flash drive and presenting the page content in the browser without triggering a dialog box that impedes user experience;
the auto-run routine causing the user device to determine that internet connectivity is available;
the auto-run routine causing the user device to determine that updated media content is available to replace default media content for a portion of media content associated with the page content;
the auto-run routine causing the user device to obtain the updated media content from a remote content server and presenting the updated media content in the browser associated with the page content without triggering a dialog box that impedes user experience;
the auto-run routine causing the user device to determine that updated media content is not available to replace default media content for a portion of media content associated with the page content; and
the auto-run routine causing the user device to obtain default media content stored on the USB flash drive and presenting the default media content in the browser associated with the page content without triggering a dialog box that impedes user experience.
